(19) United States
(12) Patent Application Publication
(10) Pub. No.: US 2022/0101364 A1
(43) Pub. Date: Mar. 31, 2022

(54) CONTROL APPARATUS AND METHOD

(71) Applicant: TOYOTA JIDOSHA KABUSHIKI KAISHA, Toyota-shi Aichi-ken (JP)

(72) Inventors: Shin Sakurada, Toyota-shi (JP); Yasuhiro Baba, Gifu-ken (JP); Shuichi Sawada, Nagoya-shi (JP); Shintaro Matsutani, Kariya-shi (JP); Yurika Tanaka, Yokosuka-shi (JP); Ryosuke Kobayashi, Nagakute-shi (JP); Genshi Kuno, Kasugai-shi (JP); Tomoya Makino, Kariya-shi (JP)

(73) Assignee: TOYOTA JIDOSHA KABUSHIKI KAISHA, Toyota-shi Aichi-ken (JP)

(21) Appl. No.: 17/482,900

(22) Filed: Sep. 23, 2021

(30) Foreign Application Priority Data
Sep. 28, 2020 (JP) 2020-162722

(51) Int. Cl. G06Q 30/02

(52) U.S. Cl. CPC G06Q 30/0224; H02N 2/001

(57) ABSTRACT

A control apparatus includes a controller configured to identify a section on which a user can travel by either passenger carrying apparatus or walking, as a rewarding section, and determine a reward to be provided to the user, upon determining that the user has traveled on the rewarding section by walking.

### CROSS-REFERENCE TO RELATED APPLICATION

This application claims priority to Japanese Patent Application No. 2020-162722, filed on Sep. 28, 2020, the entire contents of which are incorporated herein by reference.

### TECHNICAL FIELD

The present disclosure relates to a control apparatus and a method.

### BACKGROUND

Technology for managing operation of passenger carrying apparatuses such as elevators is known. For example, patent literature (PTL) 1 discloses technology for analyzing a waiting time period that occurs at an elevator hall, and setting an operation plan for the elevator so as to save power consumption.

### CITATION LIST

### Patent Literature

PTL 1: JP 2019-218160 A

### SUMMARY

However, there is still room for improvement regarding operation of passenger carrying apparatuses such as elevators.

It would be helpful to implement appropriate operation of passenger carrying apparatuses including elevators.

A control apparatus according to the present disclosure includes a controller configured to:

identify a section on which a user can travel by either passenger carrying apparatus or walking, as a rewarding section; and

determine a reward to be provided to the user, upon determining that the user has traveled on the rewarding section by walking.

A method according to the present disclosure executed by a terminal apparatus configured to communicate with a control apparatus configured to identify a section on which a user can travel by either passenger carrying apparatus or walking, as a rewarding section, and determine a reward to be provided to the user, upon determining that the user has traveled on the rewarding section by walking, the method includes:

detecting positional information for the user; and

transmitting the detected positional information to the control apparatus.

A method according to the present disclosure executed by a control apparatus includes:

identifying a section on which a user can travel by either passenger carrying apparatus or walking, as a rewarding section; and

determining a reward to be provided to the user, upon determining that the user has traveled on the rewarding section by walking.

According to the present disclosure, users are more likely to travel by walking, rather than by passenger carrying apparatus. Therefore, it is possible to implement appropriate operation of passenger carrying apparatuses including elevators.

### BRIEF DESCRIPTION OF THE DRAWINGS

In the accompanying drawings:

FIG. 1 is a diagram illustrating a configuration of a system according to the present disclosure;

FIG. 2 is a block diagram illustrating a configuration of a control apparatus according to the present disclosure;

FIG. 3 is a diagram illustrating an example of a demand level reference value database according to the present disclosure;

FIG. 4 is a diagram illustrating an example of a consumed electrical energy reference value database according to the present disclosure;

FIG. 5 is a block diagram illustrating a configuration of a terminal apparatus according to the present disclosure;

FIG. 6A is a diagram illustrating operations of the system according to the present disclosure;

FIG. 6B is a diagram illustrating operations of the system according to the present disclosure;

FIG. 7 is a diagram illustrating operations of a controller of the control apparatus according to the present disclosure;

FIG. 8 is a diagram for explaining a rewarding section according to the present disclosure;

FIG. 9 is a diagram illustrating an example of a screen displayed on an output interface of the terminal apparatus according to the present disclosure; and

FIG. 10 is a diagram for explaining a rewarding section according to a variation.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified, as appropriate.

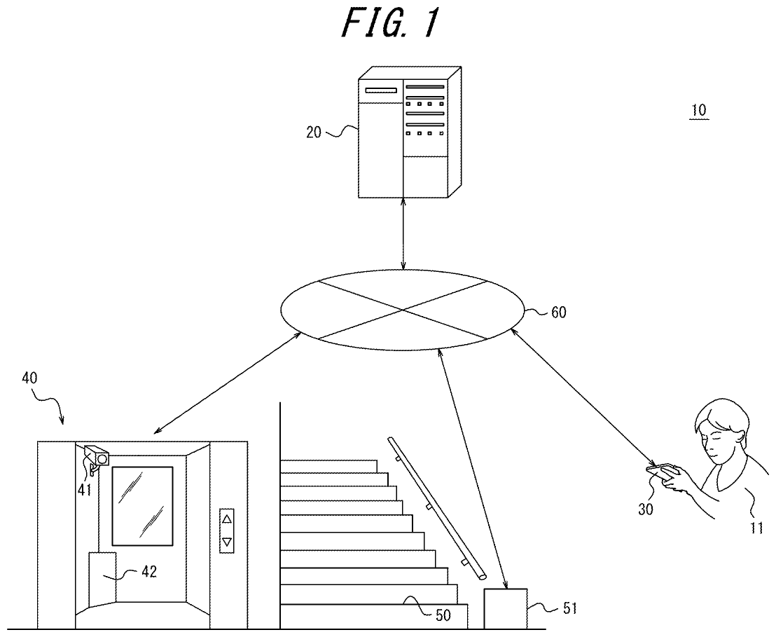

A configuration of a system 10 according to the present embodiment will be described with reference to FIG. 1.

The system 10 according to the present embodiment includes a control apparatus 20, a terminal apparatus 30, a passenger carrying apparatus 40, and a power generation floor 50.

The control apparatus 20 can communicate with the terminal apparatus 30, the passenger carrying apparatus 40, and the power generation floor 50 via a network 60.

The network 60 includes the Internet, at least one WAN, at least one MAN, or a combination thereof. The term “WAN” is an abbreviation of wide area network. The term “MAN” is an abbreviation of metropolitan area network. The network 60 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

The control apparatus 20 is installed in a facility such as a data center. The control apparatus 20 is, for example, a server that belongs to a cloud computing system or another type of computing system.

The terminal apparatus 30 is held by a user 11. The terminal apparatus 30 is, for example, a mobile device such as a mobile phone, a smartphone, a wearable device, or a tablet, or a PC. The term “PC” is an abbreviation of personal computer. The “wearable device” is specifically a mobile device that is wearable on the body of the user 11, such as a wristwatch-type device.

The passenger carrying apparatus 40 is an apparatus that can transport passengers a certain distance. The passenger carrying apparatus 40 is an elevator that can transport passengers to upper and lower floors, in the present embodiment, but is not limited to this, and may be an escalator, a moving walkway, or the like. The “moving walkway” is an apparatus that transports passengers on a belt in a horizontal or inclined direction. In the present embodiment, the passenger carrying apparatus 40 is provided in a commercial facility. The passenger carrying apparatus 40 may be provided in a facility such as an accommodation facility, a public facility, or an apartment complex. The passenger carrying apparatus 40 includes a passenger surveillance camera 41 and a power monitoring device 42. The passenger surveillance camera 41 captures an image of the inside of the passenger carrying apparatus 40. The passenger surveillance camera 41 includes a memory for storing the captured image. The power monitoring device 42 detects electrical energy consumed by the passenger carrying apparatus 40 during operation over time. The power monitoring device 42 includes a memory for storing rated power consumption of the passenger carrying apparatus 40. The image captured by the passenger surveillance camera 41 and the rated power consumption of the passenger carrying apparatus 40 may be stored in a storage device of an external apparatus. Each of the passenger surveillance camera 41 and the power monitoring device 42 includes a communication interface, and can communicate with the control apparatus 20.

The power generation floor 50 is a floor having a mechanism for generating electric power by a person walking on the floor. The power generation floor 50 is provided in a rewarding section, specifically on step surfaces of stairs or floor surfaces of a passage or the like in the rewarding section. In the present embodiment, the power generation floor 50 is provided on the step surfaces of the stairs. The power generation floor 50 is configured such that piezoelectric elements and a vibration plate are accommodated in each of casings that have a rectangular shape such as a square shape, and the casings are connected and laid on the floor surface. The piezoelectric elements are elements that can generate electric power by being deformed under pressure. The piezoelectric elements are bonded to the vibration plate. In the power generation floor 50, a person travels on each casing, thereby transmitting vibrations to the vibration plate, and the piezoelectric elements are deformed, thereby generating electric power. The generated electric power is supplied to a power storage device, and can be used by a management company or the like of a facility in which the power generation floor 50 is provided. The power generation floor 50 includes a power generation detection device 51 for detecting generated electrical energy. The power generation detection device 51 includes a communication interface, and can communicate with the control apparatus 20. The power generation detection device 51 is capable of near field communication with the terminal apparatus 30 held by the user 11. The near field communication may be performed in conformity with a standard such as an infrared communication standard, Bluetooth® (Bluetooth is a registered trademark in Japan, other countries, or both), for example. The power generation detection device 51 includes a memory, and stores a user identifier received from the terminal apparatus 30 and the detected generated electrical energy in association with each other.

An outline of the present embodiment will be described with reference to FIG. 1.

In the system 10 illustrated in FIG. 1, the control apparatus 20 identifies a section on which the user 11 can travel by either passenger carrying apparatus 40 or walking, as a rewarding section. The control apparatus 20 determines a reward to be provided to the user, upon determining that the user 11 has traveled on the rewarding section by walking. The control apparatus 20 further acquires operation information indicating operation status of the passenger carrying apparatus 40 from the passenger carrying apparatus 40. The reward is determined based on the operation information.

The “rewarding section” is a section on which the user 11 can travel by either passenger carrying apparatus 40 or walking. The rewarding section is, for example, a section in which both an elevator and stairs or a slope are provided, a section in which both an escalator and stairs or a slope are provided, a section in which both a moving walkway and stairs, a sidewalk, or a slope are provided, or the like. The rewarding section is registered in advance on map information, and is stored in the memory 22 of the control apparatus 20. In the present embodiment, the rewarding section is a section in which an elevator and stairs are provided as an entrance of a commercial facility. In a case in which the rewarding section exists in a road along a path ahead in the traveling direction of the user 11, who is traveling, the rewarding section is identified by the control apparatus 20 based on travel information for the user 11. The “travel information” includes information indicating the current position of the user 11, who holds the terminal apparatus 30, detected by the terminal apparatus 30. The “operation information” includes information indicating operation status of the passenger carrying apparatus 40, such as a demand level, consumed electrical energy, rated power consumption, or the like of the passenger carrying apparatus 40. The operation information may include information such as operating hours, an operating speed, or the like of the passenger carrying apparatus 40. The “demand level” refers to the number of passengers in the passenger carrying apparatus 40, or in a case in which the passenger carrying apparatus 40 is an escalator or a moving walkway, the number of passengers on the escalator or the moving walkway, in the present embodiment, but is not limited to these, and may be set freely. The “consumed electrical energy” refers to electrical energy consumed by the passenger carrying apparatus 40 during operation. The consumed electrical energy is detected by the power monitoring device 42 over time. The “rated power consumption” refers to the maximum value of electric power at which the passenger carrying apparatus 40 can operate stably and continuously. The “reward” includes discount coupons that the user 11 can use at a real store or a virtual store. The reward is not limited to the discount coupons, but includes points or the like that can be accumulated and redeemed for goods. The reward is determined by the control apparatus 20, and stored in the memory 22 of the control apparatus 20 as reward information to be notified to the user 11. The notification to the user 11 may be in the form of a text message, an image, audio, or the like. The reward information may be displayed on the terminal apparatus 30, in the form of bar codes or QR Codes® (QR codes is a registered trademark in Japan, other countries, or both) or the like, which can be read by a vending system of the store.

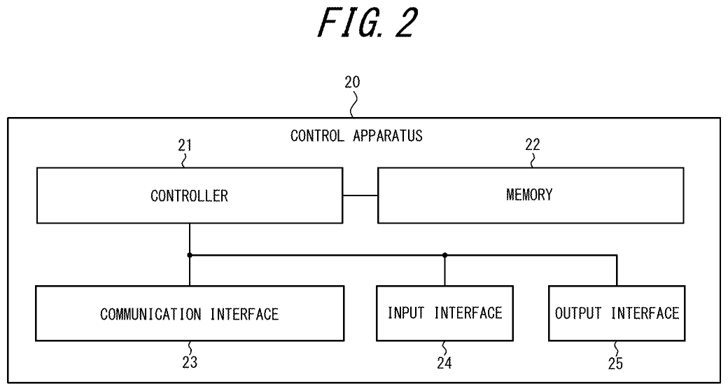

A configuration of the control apparatus 20 according to the present embodiment will be described with reference to FIG. 2.

The control apparatus 20 includes a controller 21, a memory 22, a communication interface 23, an input interface 24, and an output interface 25.

The controller 21 includes at least one processor, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The dedicated circuit is, for example, an FPGA or an ASIC. The term “FPGA” is an abbreviation of field-programmable gate array. The term “ASIC” is an abbreviation of application specific integrated circuit. The controller 21 executes processes related to operations of the control apparatus 20 while controlling components of the control apparatus 20. The controller 21 determines the reward to be provided to the user 11, while referring to various databases stored in the memory 22, which will be described in detail below.

The communication interface 23 includes at least one interface for communication. The interface for communication is, for example, a LAN interface. The communication interface 23 receives information to be used for the operations of the control apparatus 20, and transmits information obtained by the operations of the control apparatus 20.

The input interface 24 includes at least one interface for input. The interface for input is, for example, a physical key, a capacitive key, a pointing device, a touch screen integrally provided with a display, or a microphone. The input interface 24 accepts an operation to input information to be used for the operations of the control apparatus 20. The input interface 24, instead of being included in the control apparatus 20, may be connected to the control apparatus 20 as an external input device. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs information resulting from operations of the control apparatus 20. The output interface 25, instead of being included in the control apparatus 20, may be connected to the control apparatus 20 as an external output device. As the connection method, any technology such as USB, HDMI®, or Bluetooth® can be used.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores information for use in operations of the control apparatus 20 and information resulting from operations of the control apparatus 20. The memory 22 stores a system program, an application program, map information, a demand level reference value database for the passenger carrying apparatus 40, and a consumed electrical energy reference value database for the passenger carrying apparatus 40.

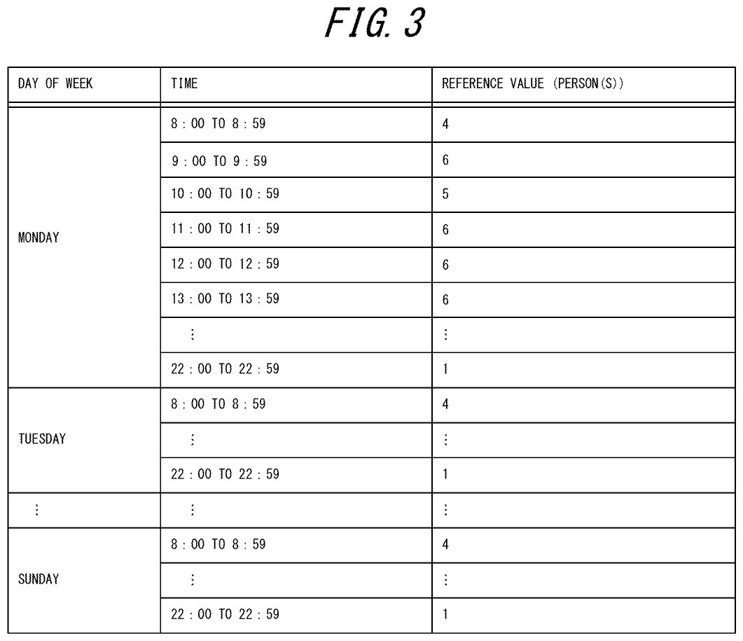

An example of the demand level reference value database is illustrated in FIG. 3. Referring to FIG. 3, each reference value of demand levels of the passenger carrying apparatus 40 is indicated for a corresponding time slot of a corresponding day of the week, in the form of a table. Each reference value of demand levels is an average value of the number of passengers in the passenger carrying apparatus 40 in the corresponding time slot on the corresponding day of the week. The demand level reference value database is created by the controller 21 in the following manner. First, the controller 21 constantly or periodically acquires images from the passenger surveillance camera 41 in the passenger carrying apparatus 40. The controller 21 determines the number of passengers in the passenger carrying apparatus 40 as a demand level, based on each acquired image. The controller 21 obtains the average value of the determined demand levels for each time slot of each day of the week, and creates the demand level reference value database. For example, the controller 21 determines the number of passengers in the passenger carrying apparatus 40, namely, a demand level, from 8:00 to 8:59 every Monday morning, and averages the demand levels that have been determined over several weeks to calculate the reference value. The “reference value” is not limited to the average value, and may be set freely. Each reference value may be, for example, a median value or a mode value of demand levels in the corresponding time slot on the corresponding day of the week. In the table in FIG. 3, the information recorded in the first row following the title row indicates that the average value of the number of passengers from 8:00 to 8:59 on Monday, serving as the reference value, is 4. In FIG. 3, the time slots are divided into every single hour, but are not limited to this, and may be divided into every 30 minutes, every three hours, or the like. In the present embodiment, the operating hours of the passenger carrying apparatus 40 correspond to the business hours of the commercial facility in which the passenger carrying apparatus 40 is provided. Thus, the table in FIG. 3 indicates the reference values for time slots from 8:00 to 22:59, which are the business hours, but the time slots that may be applied are obviously not limited to these. The reference values may be stored, for example, with respect to time slots for 24 hours. The controller 21 acquires demand levels from the passenger carrying apparatus 40, and recalculates reference values, to thereby periodically update the demand level reference value database.

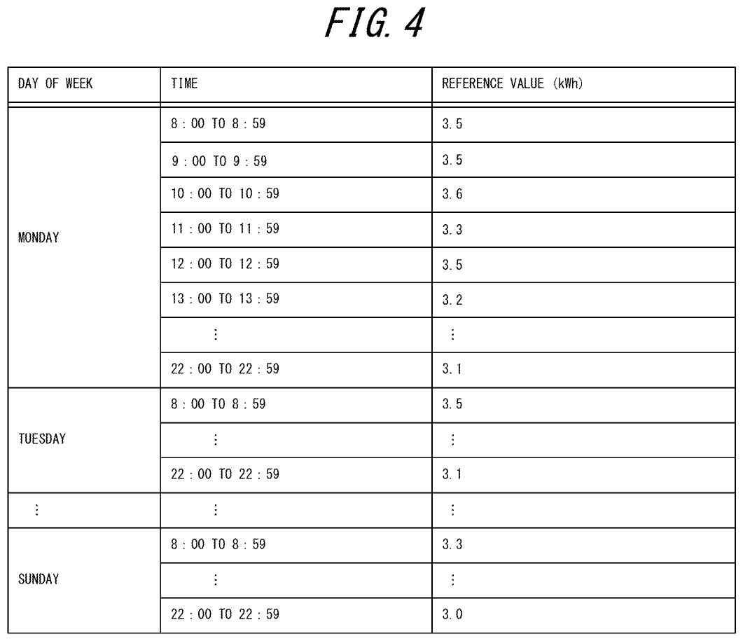

An example of the consumed electrical energy reference value database is illustrated in FIG. 4. Referring to FIG. 4, each reference value of electrical energy consumed by the passenger carrying apparatus 40 is indicated for a corresponding time slot of a corresponding day of the week, in the form of a table. Each reference value of consumed electrical energy is an average value of electrical energy consumed in the passenger carrying apparatus 40 in the corresponding time slot on the corresponding day of the week. The consumed electrical energy reference value database is created by the controller 21 in the following manner. First, the controller 21 constantly or periodically acquires consumed electrical energy from the power monitoring device 42 in the passenger carrying apparatus 40. Then, the controller 21 obtains the average value of the acquired consumed electrical energy for each time slot of each day of the week as a reference value, and creates the consumed electrical energy reference value database. For example, the controller 21 determines electrical energy consumed in the passenger carrying apparatus 40 from 8:00 to 8:59 every Monday morning, and averages the consumed electrical energy that have been determined over several weeks to calculate the reference value. The “reference value” is not limited to the average value, and may be set freely. Each reference value may be, for example, a median value or a mode value of consumed electrical energy in the corresponding time slot on the corresponding day of the week. In the table in FIG. 4, the information recorded in the first row following the title row indicates that the average value of the consumed electrical energy from 8:00 to 8:59 on Monday, serving as the reference value, is 3.5 kWh. In FIG. 4, the time slots are divided into every single hour, but are not limited to this, and may be divided into every 30 minutes, every three hours, or the like. As described for the demand level reference value database, the table in FIG. 4 indicates the reference values for time slots that correspond to the operating hours of the passenger carrying apparatus 40, but the time slots that may be applied are not limited to these. The controller 21 acquires consumed electrical energy from the passenger carrying apparatus 40, and recalculates reference values, to thereby periodically update the consumed electrical energy reference value database.

The controller 21 receives positional information for the terminal apparatus 30 from the terminal apparatus 30 via the communication interface 23 to acquire positional information for the user 11 who holds the terminal apparatus 30. The controller 21 determines, while referring to the map information stored in the memory 22, a road that is within a predetermined distance ahead in the traveling direction of the user 11 in a case in which the user 11 travels along a path. The predetermined distance is, for example, 20 meters ahead of the user 11, but is not limited to this, and may be set freely. The controller 21 identifies a rewarding section that exists on the determined road, and determines whether the user 11 has traveled on the rewarding section by walking. The determination is performed based on the positional information received from the terminal apparatus 30.

Upon determining that the user 11 has traveled on the rewarding section by walking, the controller 21 determines a reward to be provided to the user 11, as described in detail below. In the present embodiment, the reward is a discount coupon that the user 11 can use at a store within the commercial facility in which the passenger carrying apparatus 40 is provided. The controller 21 determines a discount rate of the discount coupon.

Referring to FIG. 3, a reward that is determined based on a demand level will be described. Upon determining that the user 11 has traveled on the rewarding section by walking, the controller 21 acquires a demand level as operation information, from the passenger carrying apparatus 40.

Specifically, the controller 21 acquires images from the passenger surveillance camera 41 of the passenger carrying apparatus 40 via the communication interface 23, and determines the number of passengers based on an image captured during a time period in which the user 11 is traveling on the rewarding section. Then, the controller 21 stores the number of the passengers in the memory 22 as the demand level. The controller 21 refers to the memory 22 and reads the reference value corresponding to the time slot to which the time of the acquisition of the demand level belongs, from the demand level reference value database. The controller 21 compares the demand level acquired from the passenger carrying apparatus 40 with the read reference value, and determines the reward to be higher as the demand level exceeds the reference value by a higher ratio. In the present embodiment, the controller 21 determines the discount rate of the discount coupon, as the reward, to be higher by 0.5% as the acquired demand level exceeds the read reference value by one more person. For example, suppose that the demand level acquired by the controller 21 from the passenger carrying apparatus 40 is 10 persons, and the time of the acquisition is 9:30 on Monday morning. In this case, the controller 21 reads the reference value corresponding to the time slot to which the time of the acquisition of the demand level belongs, from the demand level reference value database. Referring to FIG. 3, the reference value corresponding to the 9:00 hour on Monday morning is six persons. The controller 21 determines a discount rate of 2% as the reward, which is calculated by multiplying the number of four persons, which is the difference between the acquired demand level of 10 persons and the read reference value of six persons, by 0.5%.

Referring to FIG. 4, a reward that is determined based on consumed electrical energy will be described. Upon determining that the user 11 has traveled on the rewarding section by walking, the controller 21 acquires consumed electrical energy as operation information, from the passenger carrying apparatus 40. Specifically, the controller 21 acquires consumed electrical energy from the power monitoring device 42 of the passenger carrying apparatus 40 via the communication interface 23, and stores the consumed electrical energy in the memory 22. The controller 21 converts the acquired consumed electrical energy into consumed electrical energy per one hour. The controller 21 refers to the memory 22 and reads the reference value corresponding to the time slot to which the time of the acquisition of the consumed electrical energy belongs, from the consumed electrical energy reference value database. The controller 21 compares the acquired consumed electrical energy with the read reference value, and determines the reward to be higher as the consumed electrical energy exceeds the reference value by a higher ratio. In the present embodiment, the controller 21 determines the discount rate of the discount coupon, as the reward, to be higher by 1% as the consumed electrical energy exceeds the reference value by 0.1 kWh more. In the present embodiment, suppose that the consumed electrical energy acquired by the controller 21 from the passenger carrying apparatus 40 is 0.01 kWh, and the passenger carrying apparatus 40 has operated for 10 seconds. Also, suppose that the time of the acquisition is 9:30 on Monday morning. In this case, the controller 21 first converts the acquired consumed electrical energy of 0.01 kWh into consumed electrical energy per one hour, to obtain 3.6 kWh. Next, the controller 21 reads the reference value corresponding to the 9:00 hour on Monday morning from the consumed electrical energy reference value database. Referring to FIG. 4, the reference value corresponding to the 9:00 hour on Monday morning is 3.5 kWh. The controller 21 calculates a value of 0.1 kWh, which is the difference between the acquired consumed electrical energy of 3.6 kWh and the read reference value of 3.5 kWh, and determines a discount rate of 1% as the reward.

A reward that is determined based on rated power consumption will be described. Upon determining that the user 11 has traveled on the rewarding section by walking, the controller 21 acquires rated power consumption as operation information, from the passenger carrying apparatus 40.

Specifically, the controller 21 acquires rated power consumption from the power monitoring device 42 of the passenger carrying apparatus 40 via the communication interface 23, and stores the rated power consumption in the memory 22. The controller 21 determines the reward to be higher as the acquired rated power consumption increases. In the present embodiment, the controller 21 determines the discount rate of the discount coupon, as the reward, to be higher by 0.1% as the rated power consumption increases by 1 kW. In the present embodiment, suppose that the rated power consumption acquired by the controller 21 from the passenger carrying apparatus 40 is 12 kW. In this case, the controller 21 determines a discount rate of 1.2% as the reward.

A reward that is determined based on generated electrical energy will be described. Generated electrical energy is electrical energy that is generated by the user 11 traveling on the power generation floor 50. Upon determining that the user 11 has traveled on the rewarding section by walking, the controller 21 acquires electrical energy generated by the user 11 traveling, from the power generation detection device 51 of the power generation floor 50 via the communication interface 23, and stores the generated electrical energy in the memory 22. The controller 21 determines the reward to be higher as the acquired generated electrical energy increases. In the present embodiment, the controller 21 determines the discount rate, as the reward, to be higher by 1% as the generated electrical energy increases by 1 Ws. In the present embodiment, suppose that the generated electrical energy acquired by the controller 21 from the power generation floor 50 is 1.5 Ws. In this case, the controller 21 determines a discount rate of 1.5% as the reward.

The timings for acquiring the demand level, the consumed electrical energy, the rated power consumption, and the generated electrical energy that are described above are not limited to the above-described timings, and may occur, for example, while the user 11 is traveling on the rewarding section. The controller 21 may acquire the demand level, the consumed electrical energy, the rated power consumption, and the generated electrical energy that are described above, from an external management apparatus that controls the passenger carrying apparatus 40 or the power generation floor 50. A value of the discount rate for the controller 21 to determine the reward is not limited to the above-described value, and may be set freely.

The controller 21 finally determines a reward by summation of the respective rewards determined based on the demand level, the consumed electrical energy, the rated power consumption, and the generated electrical energy that are described above, and stores the reward as reward information indicating the reward, in the memory 22. The controller 21 outputs the reward information to the terminal apparatus 30, to thereby provide the user 11 with the reward.

The functions of the control apparatus 20 are realized by execution of a control program according to the present embodiment by a processor corresponding to the controller 21. That is, the functions of the control apparatus 20 are realized by software. The control program causes a computer to execute the operations of the control apparatus 20, to thereby cause the computer to function as the control apparatus 20. That is, the computer executes the operations of the control apparatus 20 in accordance with the control program to thereby function as the control apparatus 20.

The program can be recorded on a non-transitory computer readable medium. The non-transitory computer readable medium is, for example, a magnetic recording device, an optical disc, a magneto-optical recording medium, or a semiconductor memory. The program is distributed by sale, transfer of ownership, or rental of a portable recording medium such as a DVD or a CD-ROM on which the program is recorded. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

The computer temporarily stores in a main memory, for example, a program recorded on a portable recording medium, or a program transferred from the server. Then, the computer reads the program stored in the main memory using a processor, and executes processes in accordance with the read program using the processor. The computer may read a program directly from the portable recording medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a dedicated circuit corresponding to the controller 21. That is, some or all of the functions of the control apparatus 20 may be realized by hardware.

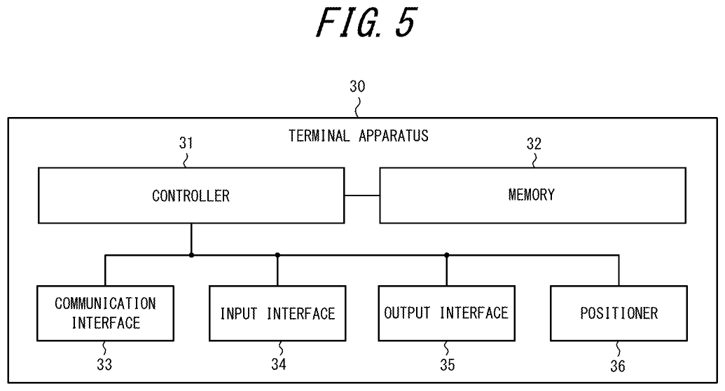

A configuration of the terminal apparatus 30 according to the present embodiment will be described with reference to FIG. 5.

The terminal apparatus 30 includes a controller 31, a memory 32, a communication interface 33, an input interface 34, an output interface 35, and a positioner 36.

The controller 31 includes at least one processor, at least one dedicated circuit, or a combination thereof. The processor is a general purpose processor such as a CPU or a GPU, or a dedicated processor that is dedicated to specific processing. The dedicated circuit is, for example, an FPGA or an ASIC. The controller 31 executes processes related to operations of the terminal apparatus 30 while controlling components of the terminal apparatus 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores information for use in operations of the terminal apparatus 30 and information resulting from operations of the terminal apparatus 30.

The communication interface 33 includes at least one interface for communication. The interface for communication is, for example, an interface compliant with a mobile communication standard such as LTE, the 4G standard, or the 5G standard, an interface compliant with a short-range wireless communication standard such as Bluetooth®, or a LAN interface. The term “LTE” is an abbreviation of Long Term Evolution. The term “4G” is an abbreviation of 4th generation. The term “5G” is an abbreviation of 5th generation. The communication interface 33 receives information for use in operations of the terminal apparatus 30, and transmits information resulting from operations of the terminal apparatus 30.

The input interface 34 includes at least one interface for input. The interface for input is, for example, a physical key, a capacitive key, a pointing device, a touch screen integrally provided with a display, or a microphone. The input interface 34 accepts an operation to input information to be used for the operations of the terminal apparatus 30. The input interface 34, instead of being included in the terminal apparatus 30, may be connected to the terminal apparatus 30 as an external input device. As the connection method, any technology such as USB, HDMI®, or Bluetooth® can be used

The output interface 35 includes at least one interface for output. The interface for output is, for example, a display, a speaker, or a vibration motor. The display is, for example, an LCD or an organic EL display. The output interface 35 outputs information resulting from operations of the terminal apparatus 30. The output interface 35, instead of being included in the terminal apparatus 30, may be connected to the terminal apparatus 30 as an external output device. As the connection method, any technology such as USB, HDMI®, or Bluetooth® can be used.

The positioner 36 includes at least one GNSS receiver. The term “GNSS” is an abbreviation of global navigation satellite system. GNSS includes, for example, GPS, QZSS, BeiDou, GLONASS, and/or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positioner 36 measures the position of the terminal apparatus 30.

The functions of the terminal apparatus 30 are realized by execution of a terminal program according to the present embodiment by a processor corresponding to the controller 31. That is, the functions of the terminal apparatus 30 are realized by software. The terminal program causes a computer to execute the operations of the terminal apparatus 30, to thereby cause the computer to function as the terminal apparatus 30. That is, the computer executes operations of the terminal apparatus 30 in accordance with the terminal program to thereby function as the terminal apparatus 30.

Some or all of the functions of the terminal apparatus 30 may be realized by a dedicated circuit corresponding to the controller 31. That is, some or all of the functions of the terminal apparatus 30 may be realized by hardware.

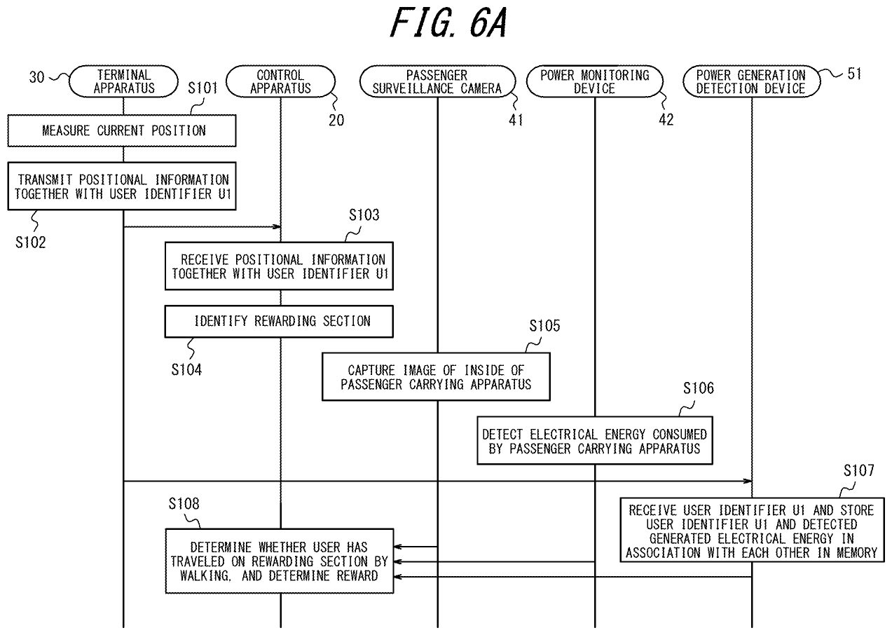

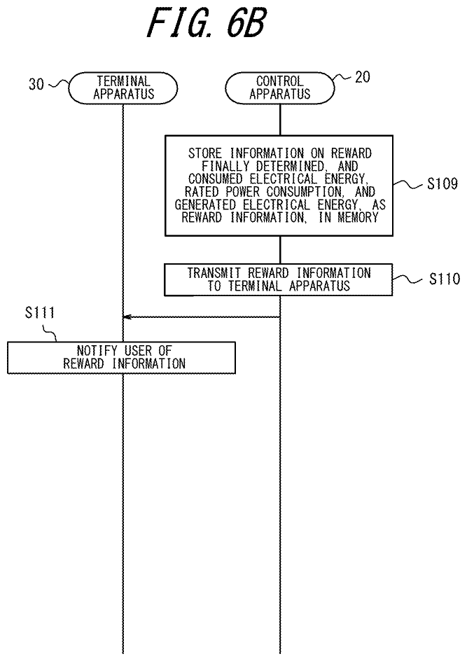

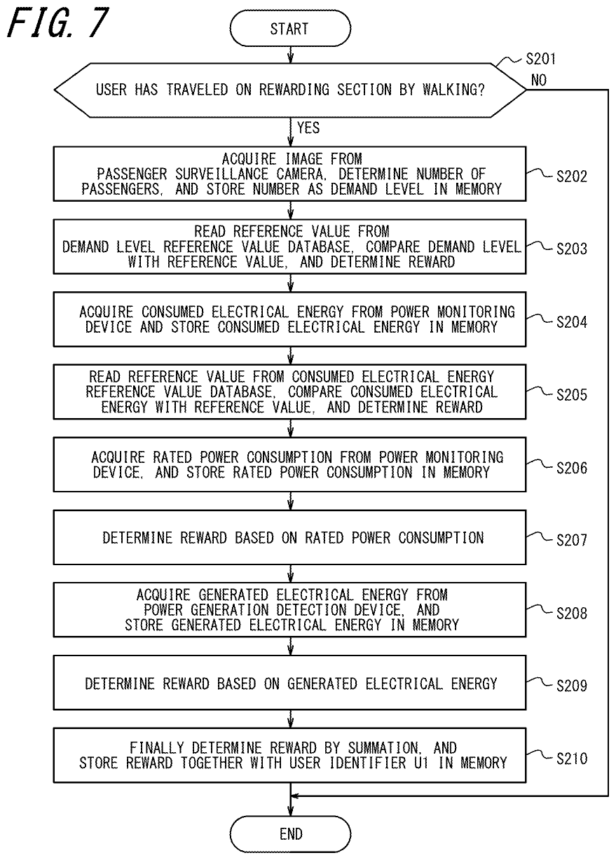

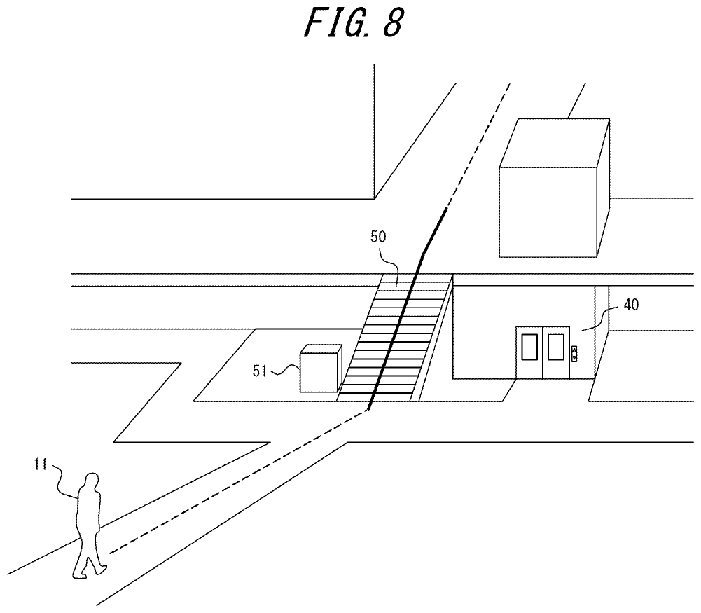

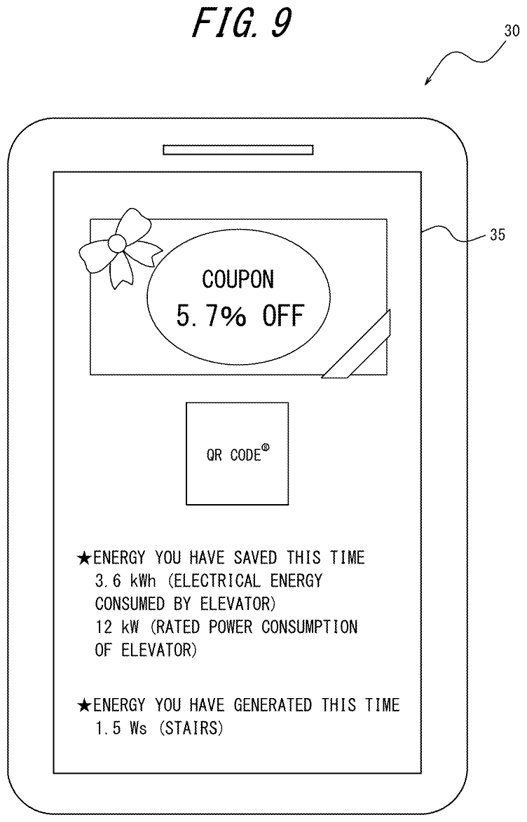

Operations of the system 10 according to the present embodiment will be described with reference to FIGS. 3, 4, 6A, 6B, 7, 8 and 9. These operations correspond to a method according to the present embodiment. In this example, suppose that the user identifier corresponding to the user 11 is “Ul”. In this example, suppose that the reward is a discount coupon that can be used in a commercial facility inside a building in which the passenger carrying apparatus 40 is provided. FIG. 3 is a diagram illustrating an example of the demand level reference value database according to the present embodiment. FIG. 4 is a diagram illustrating an example of the consumed electrical energy reference value database according to the present embodiment. FIGS. 6A and 6B illustrate processing flows of the entire system 10 according to the present embodiment. FIG. 7 illustrates operations of the controller 21 of the control apparatus 20. FIG. 8 illustrates an example of a rewarding section. FIG. 9 illustrates an example of a screen displayed on the output interface 35 of the terminal apparatus 30.

In step S101 of FIG. 6A, the positioner 36 of the terminal apparatus 30 measures the current position of the terminal apparatus 30. The controller 31 of the terminal apparatus 30 acquires, as positional information for the user 11, information indicating the position measured by the positioner 36. The controller 31 stores the acquired positional information in the memory 32. In step S102, the controller 31 refers to the memory 32, and transmits the positional information together with the user identifier “Ul” for the user 11, to the control apparatus 20, via the communication interface 33.

In step S103, the controller 21 of the control apparatus 20 receives the positional information and the user identifier “Ul” for the user 11 from the terminal apparatus 30, via the communication interface 23. The controller 21 constantly receives positional information and the user identifier “Ul” for the user 11 from the terminal apparatus 30.

In step S104, the controller 21 determines a road that is within a predetermined distance ahead in the traveling direction of the user 11 in a case in which the user 11 travels along a path, based on the positional information for the user 11 acquired from the terminal apparatus 30 and the map information stored in the memory 22. The controller 21 identifies a rewarding section that exists on the determined road. In FIG. 8, the road along the path ahead in the traveling direction of the user 11 is illustrated by dotted lines, and the rewarding section detected by the controller 21 is illustrated by a solid line. In this example, the passenger carrying apparatus 40 and stairs adjacent to the passenger carrying apparatus 40 exist 20 meters ahead in the traveling direction of the user 11. The controller 21 identifies a section on which a user can travel by either passenger carrying apparatus 40 or walking, as the rewarding section. The controller 21 stores the identified rewarding section in the memory 22.

In step S105, the passenger surveillance camera 41 of the passenger carrying apparatus 40 captures an image of the inside of the passenger carrying apparatus 40. The captured image is stored in the memory of the passenger surveillance camera 41.

In step S106, the power monitoring device 42 detects electrical energy consumed by the passenger carrying apparatus 40. The detected consumed electrical energy is stored in the memory of the power monitoring device 42.

In step S107, the power generation detection device 51 of the power generation floor 50 that is provided on step surfaces of the stairs detects electrical energy generated by the user 11 traveling on the power generation floor 50. The detected generated electrical energy is stored in the memory of the power generation detection device 51. Specifically, the power generation detection device 51 communicates with the terminal apparatus 30 held by the user 11 by near filed communication, and receives the user identifier “Ul” from the terminal apparatus 30. The power generation detection device 51 stores, in the memory of the power generation detection device 51, as electrical energy generated by the user 11, the detected generated electrical energy in association with the received user identifier.

In step S108, the controller 21 determines whether the user 11 has traveled on the rewarding section by walking, and performs operations of determining the reward to be provided to the user 11.

FIG. 7 illustrates a specific processing flow of operations of the controller 21 in step S108 of FIG. 6A.

First, in step S201, the controller 21 detects that the user 11 has traveled on the rewarding section by walking. In a case in which the controller 21 does not detect that the user 11 has traveled on the rewarding section by walking, the controller 21 ends the processing. The controller 21 performs detection based on the positional information acquired from the terminal apparatus 30. In this example, the controller 21 confirms that the user 11 has walked up the stairs in FIG. 8 based on the positional information, and detects that the user 11 has traveled on the rewarding section by walking. Upon detecting that the user has traveled on the rewarding section by walking, the controller 21 determines the reward to be provided to the user 11, as described in detail below.

In steps S202 to S207, the controller 21 first acquires operation information indicating operation status of the passenger carrying apparatus 40 from the passenger carrying apparatus 40. Then, the controller 21 determines the reward based on the operation information.

In step S202, the controller 21 acquires the image from the passenger surveillance camera 41 of the passenger carrying apparatus 40. The controller 21 determines the number of passengers based on the image captured during a time period in which the user 11 is traveling on the rewarding section, and acquires a demand level by storing the number as the demand level in the memory 22. In step S203, the controller 21 refers to the memory 22, and reads the reference value corresponding to the time slot to which the time of the acquisition of the demand level belongs, from the demand level reference value database. The controller 21 compares the demand level with the read reference value to determine a reward to be provided to the user 11. The controller 21 determines the discount rate of the discount coupon, as the reward, to be higher by 0.5% as the demand level exceeds the reference value by one more person. In this example, the demand level acquired by the controller 21 from the passenger carrying apparatus 40 is 10 persons, and the time of the acquisition is 9:30 on Monday morning. The controller 21 reads the reference value corresponding to the 9:00 hour on Monday morning, from the demand level reference value database illustrated in FIG. 3. Referring to FIG. 3, the reference value corresponding to the 9:00 hour on Monday morning is six persons. The controller 21 determines a discount rate of 2% as the reward, which is calculated by multiplying the number of four persons, which is the difference between the acquired demand level of 10 persons and the read reference value six persons, by 0.5%.

Next, in step S204, the controller 21 acquires, from the power monitoring device 42 of the passenger carrying apparatus 40, electrical energy consumed by the passenger carrying apparatus 40 during a time period in which the user 11 is traveling on the rewarding section, and stores the consumed electrical energy in the memory 22. In step S205, the controller 21 refers to the memory 22 and reads the reference value corresponding to the time slot to which the time of the acquisition of the consumed electrical energy belongs, from the consumed electrical energy reference value database. The controller 21 compares the consumed electrical energy with the read reference value to determine a reward to be provided to the user 11. The controller 21 determines the reward to be higher as the consumed electrical energy exceeds the reference value by a higher ratio. In this example, the controller 21 determines the discount rate, as the reward, to be higher by 1% as the consumed electrical energy exceeds the reference value by 0.1 kWh more. The consumed electrical energy acquired by the controller 21 from the passenger carrying apparatus 40 is 0.01 kWh, and the passenger carrying apparatus 40 has operated for 10 seconds. Also, the time of the acquisition of is 9:30 on Monday morning. The controller 21 first converts the acquired consumed electrical energy of 0.01 kWh into consumed electrical energy per one hour, to obtain 3.6 kWh. Next, the controller 21 reads the reference value corresponding to the 9:00 hour on Monday morning from the consumed electrical energy reference value database. Referring to FIG. 4, the reference value corresponding to the 9:00 hour on Monday morning is 3.5 kWh. The controller 21 calculates a value of 0.1 kWh, which is the difference between the acquired consumed electrical energy of 3.6 kWh and the read reference value of 3.5 kWh, and determines a discount rate of 1% as the reward.

Next, in step S206, the controller 21 acquires rated power consumption of the passenger carrying apparatus 40 from the power monitoring device 42 of the passenger carrying apparatus 40, and stores the rated power consumption in the memory 22. In step S207, the controller 21 determines a reward to be higher as the acquired rated power consumption increases. In this example, the controller 21 determines the discount rate, as the reward, to be higher by 0.1% as the rated power consumption increases by 1 kW. The rated power consumption acquired by the controller 21 from the passenger carrying apparatus 40 is 12 kW. Thus, the controller 21 determines a discount rate of 1.2% as the reward.

Next, in step S208, the controller 21 acquires electrical energy generated by the user 11 traveling on the power generation floor 50, from the power generation detection device 51 of the power generation floor 50. In step S209, the controller 21 determines a reward to be higher as the acquired generated electrical energy increases. In this example, the controller 21 determines the discount rate, as the reward, to be higher by 1% as the generated electrical energy increases by 1 Ws. The generated electrical energy acquired by the controller 21 from the power generation floor 50 is 1.5 Ws. Thus, the controller 21 determines a discount rate of 1.5% as the reward.

Next, in step S210, the controller 21 finally determines a reward by summation of the rewards determined in step S202 to step S209. In this example, the controller 21 adds up the rewards of: the discount rate of 2% determined in step S203; the discount rate of 1% determined in step S205: the discount rate of 1.2% determined in step S207; and the discount rate of 1.5% determined in step S209, and finally determines the reward to be a discount rate of 5.7%. The controller 21 stores the finally determined reward together with the user identifier “Ul” for the user 11 in the memory 22, and ends the processing.

Next, returning to FIG. 6B, in step S109, the controller 21 stores information on the reward finally determined in step S210 of FIG. 7, and the consumed electrical energy, the rated power consumption, and the generated electrical energy that have been acquired, in the memory 22, as reward information to be notified to the user 11.

In step S110, the controller 21 transmits the reward information to the terminal apparatus 30. That is, the controller 21 outputs the determined reward, the consumed electrical energy, the rated power consumption, and the generated electrical energy, to the user 11. In this example, the controller 21 transmits the reward information notifying the user 11 of the discount rate of 5.7%, the consumed electrical energy of 3.6 kWh, the rated power consumption of 12 kW, and the generated electrical energy of 1.5 Ws, to the terminal apparatus 30 via the communication interface 23.

In step S111, the controller 31 of the terminal apparatus 30 notifies the user 11 of the reward information received from the control apparatus 20, via the output interface 35. In this example, the output interface 35 of the terminal apparatus 30 displays an image illustrated in FIG. 9. As illustrated in FIG. 9, the output interface 35 displays a diagram of a discount coupon with the discount rate of 5.7% and along with a text message “energy you have saved this time”, the consumed electrical energy of 3.6 kWh and the rated power consumption of 12 kW. In addition, the output interface 35 displays, together with a text message “energy you have generated this time”, the generated electrical energy of 1.5 Ws. Instead of being represented by the image, the notification to the user 11 may be outputted as audio through a speaker of the terminal apparatus 30. The image may include a QR Code® that can be read at a store to convey information on the discount.

As described above, the control apparatus 20 according to the present embodiment includes a controller 21 configured to identify a section on which a user 11 can travel by either passenger carrying apparatus 40 or walking, as a rewarding section, and determine a reward to be provided to the user 11, upon determining that the user 11 has traveled on the rewarding section by walking.

Since the user 11 can obtain the reward, the user 11 is more likely to travel on the rewarding section by walking, rather than by passenger carrying apparatus 40. Therefore, congestion of passengers in the passenger carrying apparatus 40 is less likely to occur. Also, the power consumption of the passenger carrying apparatus 40 can be saved. Further, the user 11 may improve their health condition by actively exercising by walking.

As described above, the control apparatus 20 according to the present embodiment further includes a communication interface 23. The controller 21 is configured to further acquire operation information indicating operation status of the passenger carrying apparatus 40 via the communication interface 23. The reward is determined based on the operation information.

Since the reward is determined based on the operation information for the passenger carrying apparatus 40, the user 11 is more likely to actively travel on the rewarding section by walking. Therefore, congestion of passengers in the passenger carrying apparatus 40 is less likely to occur. Also, the power consumption of the passenger carrying apparatus 40 can be saved.

As described above, in the present embodiment, the operation information includes a demand level of the passenger carrying apparatus 40, and the controller 21 is configured to determine the reward to be higher as the demand level exceeds a reference value by a higher ratio.

Since the reward is determined based on the demand level of the passenger carrying apparatus 40, the user 11 is more likely to actively travel on the rewarding section by walking, during a time slot in which the passenger carrying apparatus 40 is crowded. Therefore, congestion of passengers in the passenger carrying apparatus 40 is less likely to occur. Also, the power consumption of the passenger carrying apparatus 40 can be saved.

As described above, in the present embodiment, the operation information includes electrical energy consumed by the passenger carrying apparatus 40, and the controller 21 is configured to determine the reward to be higher as the consumed electrical energy exceeds a reference value by a higher ratio.

Since the reward is determined based on the electrical energy consumed by the passenger carrying apparatus 40, the user 11 is more likely to actively travel on the rewarding section by walking, during a time slot in which the passenger carrying apparatus 40 is in frequent operation. Therefore, congestion of passengers in the passenger carrying apparatus 40 is less likely to occur. Also, the power consumption of the passenger carrying apparatus 40 can be saved.

As described above, in the present embodiment, the operation information includes rated power consumption of the passenger carrying apparatus 40, and the controller 21 is configured to determine the reward to be higher as the rated power consumption increases.

Since the reward is determined based on the rated power consumption of the passenger carrying apparatus 40, in a case in which a passenger carrying apparatus 40 having a large rated power consumption is provided in the rewarding section, the user 11 is more likely to actively travel on the rewarding section by walking. Therefore, congestion of passengers in the passenger carrying apparatus 40 is less likely to occur. Also, the power consumption of the passenger carrying apparatus 40 can be saved.

As described above, in the present embodiment, a power generation floor 50 is provided in the rewarding section. The controller 21 is configured to acquire, via the communication interface 23, electrical energy generated by the user 11 traveling on the power generation floor 50 by walking. The controller 21 determines the reward to be higher as the generated electrical energy increases.

Since the reward is determined based on the generated electrical energy, the user 11 is more likely to actively travel on the rewarding section by walking. Therefore, congestion of passengers in the passenger carrying apparatus 40 is less likely to occur. Also, the power consumption of the passenger carrying apparatus 40 can be saved.

As described above, in the present embodiment, the controller 21 is configured to output the determined reward and the consumed electrical energy, the rated power consumption, and/or the generated electrical energy, to the user 11.

In addition to the reward, the consumed electrical energy after saving, the rated power consumption, and/or the electrical energy generated by walking is displayed on the terminal apparatus 30, thus providing the user 11 with an indicator that is easy to understand. Therefore, the user 11 is more likely to actively travel on the rewarding section by walking. Therefore, congestion of passengers in the passenger carrying apparatus 40 is less likely to occur. Also, the power consumption of the passenger carrying apparatus 40 can be saved.

As described above, in the present embodiment, the controller 21 is configured to receive positional information for the user 11 from the terminal apparatus 30 of the user 11 via the communication interface 23. The controller 21 determines that the user 11 has traveled on the rewarding section by walking, based on the received positional information.

Since it is accurately determined that the user 11 has traveled on the rewarding section by walking, it is easier for the user 11 to receive the reward after having traveled by walking. Therefore, the user 11 is more likely to actively travel on the rewarding section by walking, rather than by passenger carrying apparatus 40. Therefore, congestion of passengers in the passenger carrying apparatus 40 is less likely to occur. Also, the power consumption of the passenger carrying apparatus 40 can be saved.

As described above, in the present embodiment, the passenger carrying apparatus 40 comprises an elevator, an escalator and/or a moving walkway.

The user 11 is more likely to travel on the rewarding section by walking, the rewarding section being on a road that is traveled by the user 11 on a daily basis. In addition, even in a case in which the user 11 is traveling on a road that the user 11 travels for the first time, upon recognizing the rewarding section ahead, which includes an elevator, an escalator, and/or a moving walkway, the user 11 is more likely to actively travel by walking. Therefore, congestion of passengers in the passenger carrying apparatus 40 is less likely to occur. Also, the power consumption of the passenger carrying apparatus 40 can be saved.

As described above, in the present embodiment, the terminal apparatus 30, which communicates with the control apparatus 20, detects positional information for the user 11, and transmits the detected positional information to the control apparatus 20.

Since it is more accurately determined that the user 11 has traveled on the rewarding section by walking, it is easier for the user 11 to receive the reward after having traveled by walking. Therefore, the user 11 is more likely to actively travel on the rewarding section by walking. Therefore, congestion of passengers in the passenger carrying apparatus 40 is less likely to occur. Also, the power consumption of the passenger carrying apparatus 40 can be saved.

As described above, in the present embodiment, the terminal apparatus 30 transmits a user identifier corresponding to the user 11, to the power generation floor 50.

Since the electrical energy generated by the user 11 is determined more accurately, it is easier for the user 11 to receive the reward after having traveled by walking. Therefore, the user 11 is more likely to actively travel on the rewarding section by walking. Therefore, congestion of passengers in the passenger carrying apparatus 40 is less likely to occur. Also, the power consumption of the passenger carrying apparatus 40 can be saved.

As a variation of the present embodiment, the system 10 may further include a camera 70 for capturing an image of the rewarding section. In the present variation, the controller 21 of the control apparatus 20 receives the image from the camera 70 via the communication interface 23. The controller 21 determines that the user 11 has traveled on the rewarding section by walking, based on the received image.

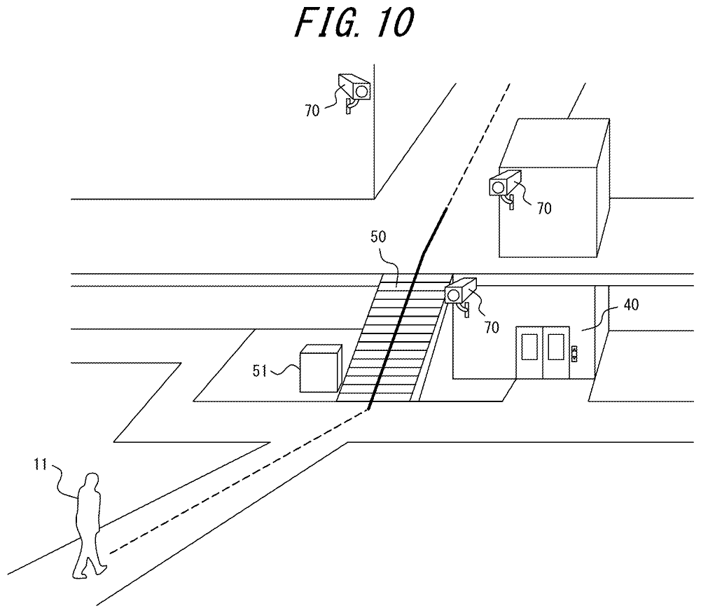

FIG. 10 illustrates an example of the rewarding section, in which cameras 70 are installed. The cameras 70 are installed outdoors or indoors so as to be able to capture images of the rewarding section. The cameras 70 each communicate with the control apparatus 20 via a communication interface and transmit a captured image to the control apparatus 20. The cameras 70 can capture images with enough resolution to recognize the user 11 traveling on the rewarding section.

According to the present variation, the controller 21 can perform the determination, in step S201 of FIG. 7, that the user 11 has traveled on the rewarding section by walking, based on the images acquired from the cameras 70, instead of or in addition to positional information acquired from the terminal apparatus 30. Specifically, the controller 21 stores a captured image of the face of the user 11 in the memory 22 in advance. The controller 21 determines whether the face of the captured image matches the face of a person who has traveled on the rewarding section by walking, included in the received image, using a face recognition technique. In a case in which the controller 21 determines that the faces match, the controller 21 determines that the user 11 has traveled on the rewarding section by walking.

The controller 21 may use the images captured by the cameras 70 to associate electrical energy generated by the power generation floor 50 with the user 11. Specifically, the controller 21 first identifies the user 11 based on the images acquired from the cameras 70, using the face recognition technique. The controller 21 identifies a time at which images of the user 11 traveling on the rewarding section are captured, and acquires electrical energy generated at the time from the power generation detection device 51 of the power generation floor 50. In this way, the controller 21 may associate the electrical energy generated by the power generation floor 50 with the user 11 to determine the reward based on the generated electrical energy.

As described above, in the present variation, the controller 21 is configured to acquire an image of the rewarding section from a camera 70 configured to capture the image, via the communication interface 23, and determine that the user 11 has traveled on the rewarding section by walking, based on the image.

Since it is more accurately determined that the user 11 has traveled on the rewarding section by walking, it is easier for the user 11 to receive the reward after having traveled by walking. Therefore, the user 11 is more likely to actively travel on the rewarding section by walking. Therefore, congestion of passengers in the passenger carrying apparatus 40 is less likely to occur. Also, the power consumption of the passenger carrying apparatus 40 can be saved.

The present disclosure is not limited to the embodiments described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

1. A control apparatus comprising a controller configured to:
identify a section on which a user can travel by either passenger carrying apparatus or walking, as a rewarding section; and
determine a reward to be provided to the user, upon determining that the user has traveled on the rewarding section by walking.

2. The control apparatus according to claim 1 further comprising a communication interface, wherein
the controller is configured to further acquire operation information indicating operation status of the passenger carrying apparatus via the communication interface, and
the reward is determined based on the operation information.

3. The control apparatus according to claim 2, wherein
the operation information includes a demand level of the passenger carrying apparatus, and
the controller is configured to determine the reward to be higher as the demand level exceeds a reference value by a higher ratio.

4. The control apparatus according to claim 2, wherein
the operation information includes electrical energy consumed by the passenger carrying apparatus, and
the controller is configured to determine the reward to be higher as the consumed electrical energy exceeds a reference value by a higher ratio.

5. The control apparatus according to claim 4, wherein the controller is configured to output the determined reward and the consumed electrical energy to the user.

6. The control apparatus according to claim 2, wherein
the operation information includes rated power consumption of the passenger carrying apparatus, and
the controller is configured to determine the reward to be higher as the rated power consumption increases.

7. The control apparatus according to claim 6, wherein the controller is configured to output the determined reward and the rated power consumption to the user.

8. The control apparatus according to claim 2, wherein
a power generation floor is provided in the rewarding section, and
the controller is configured to acquire, via the communication interface, electrical energy generated by the user traveling on the power generation floor by walking, and determine the reward to be higher as the generated electrical energy increases.

9. The control apparatus according to claim 8, wherein the controller is configured to output the determined reward and the generated electrical energy to the user.

10. The control apparatus according to claim 2, wherein the controller is configured to receive positional information for the user from a terminal apparatus of the user via the communication interface, and determine that the user has traveled on the rewarding section by walking, based on the received positional information.

11. The control apparatus according to claim 2, wherein the controller is configured to acquire an image of the rewarding section from a camera configured to capture the image, via the communication interface, and determine that the user has traveled on the rewarding section by walking, based on the image.

12. The control apparatus according to claim 1, wherein the passenger carrying apparatus comprises an elevator, an escalator, and/or a moving walkway.

13. A method executed by a terminal apparatus configured to communicate with a control apparatus configured to identify a section on which a user can travel by either passenger carrying apparatus or walking, as a rewarding section, and determine a reward to be provided to the user, upon determining that the user has traveled on the rewarding section by walking, the method comprising:
detecting positional information for the user; and
transmitting the detected positional information to the control apparatus.

14. The method according to claim 13, further comprising transmitting a user identifier corresponding to the user, to a power generation floor.

15. A method executed by a control apparatus, the method comprising:
identifying a section on which a user can travel by either passenger carrying apparatus or walking, as a rewarding section; and
determining a reward to be provided to the user, upon determining that the user has traveled on the rewarding section by walking.

16. The method according to claim 15, further comprising acquiring operation information indicating operation status of the passenger carrying apparatus,
wherein the reward is determined based on the operation information.

17. The method according to claim 16, wherein the operation information includes a demand level of the passenger carrying apparatus, the method further comprising determining the reward to be higher as the demand level exceeds a reference value by a higher ratio.

18. The method according to claim 16, wherein the operation information includes electrical energy consumed by the passenger carrying apparatus,
the method further comprising determining the reward to be higher as the consumed electrical energy exceeds a reference value by a higher ratio.

19. The method according to claim 16, wherein the operation information includes rated power consumption of the passenger carrying apparatus,
the method further comprising determining the reward to be higher as the rated power consumption increases.

20. The method according to claim 15, wherein a power generation floor is provided in the rewarding section,
the method further comprising acquiring electrical energy generated by the user traveling on the power generation floor by walking, and determining the reward to be higher as the generated electrical energy increases.
